(19) United States
(12) Patent Application Publication
(10) Pub. No.: US 2015/0341694 A1
(43) Pub. Date: Nov. 26, 2015

(54) Method And Apparatus For Using Contextual Content Augmentation To Provide Information On Recent Events In A Media Program

(71) Applicants: James G. HANKO, Redwood City, CA (US); Christopher UNKEL, Palo Alto, CA (US); Duane J. NORTHCUTT, Menlo Park, CA (US); THOMSON LICENSING, Issy les Moulineaux (FR)

(72) Inventors: James G. HANKO, Redwood City, CA (US); Christopher UNKEL, Palo Alto, CA (US); Duane J. NORTHCUTT, Menlo Park, CA (US)

(21) Appl. No.: 14/655,375

(22) PCT Filed: Dec. 30, 2012
(86) PCT No.: PCT/US2012/072244

§ 371 Date: Jun. 25, 2015

(51) Int. Cl. H04N 21/4722; H04N 21/488; H04N 21/435

(52) U.S. Cl. CPC H04N 21/4722; H04N 21/435; H04N 21/4884

(57) ABSTRACT

The present invention concerns a method and apparatus for content augmentation in an audio video system. In particular, the invention concerns storing embedded data, such as close captioning or metadata, and displaying that embedded data concerning a past event in response to a user request. The user request way be received from a remote control, via voice recognition, or facial recognition. In addition, the apparatus is operative to facilitate the viewer to scroll through buffered embedded data independent of any video being displayed. Thus the viewer may review closed captioning information for video which had previously been displayed.

### FIELD OF THE INVENTION

The present invention relates to content augmentation in an audio video system. In particular, the invention concerns storing embedded data, such as close captioning or metadata, and displaying that embedded data concerning a past event in response to a user request.

### BACKGROUND OF THE INVENTION

It is common for audio video programming viewers to misunderstand portions of a broadcast. This can occur as a result of low volume, noise in the viewing environment, accents, or the like. Thanks to devices such as digital video recorders, digital video disk players and video cassette recorders, a viewer could rewind the portion of the video missed. Unfortunately, in a group viewing environment, this is not an option without interrupting the viewing experience of the other viewers. Under these circumstances, a viewer who missed out on a part of a show would either disturb his or her co-watchers to ask a question, or they would have to rewind the content (if possible) to re-listen and try to understand what was said. If that did not work, he or she might try to rewind again and enable closed-captioning to try to read a transcript of the dialog. However, closed caption systems normally have to be enabled for a while before they start showing any text, so this may not work the first time until or unless the viewer rewinds again further to adjust for the lag. Therefore, this can be a time consuming and error prone method for discovering the missing information. Asking another viewer what was said or had occurred, but this has the drawbacks of likely annoying the other viewers and also preventing anyone from following what happens next. It would be desirable for a system to permit one user to catch up on the lost element without disturbing other viewers (e.g. family members) who may be watching the show at the same time.

### SUMMARY OF THE INVENTION

In one aspect, the present invention involves a video signal processing apparatus comprising an input for receiving an audio video signal, a processor for extracting auxiliary information from said audio video signal, for generating a video stream in response to said audio video signal and said extracted auxiliary information wherein said video stream includes a first portion of said auxiliary information in response to a first request and a second portion of said auxiliary information in response to a second request, a memory for buffering said auxiliary information, and an output for coupling said video stream to a display.

In another aspect, the invention also involves a method of processing a signal comprising the steps of, extracting auxiliary information from an audio video signal, buffering said auxiliary information, displaying a video stream extracted from said audio video signal, displaying a first portion of said auxiliary information in response to a first request, and displaying a second portion of said auxiliary information in response to a second request.

### BRIEF DESCRIPTION OF THE DRAWINGS

FIG. 1 is a block diagram of an exemplary embodiment of an audio video reception system according to the present invention;

FIG. 2 is an exemplary illustration of a television with closed captioning capabilities according to the present invention;

FIG. 3 is a functional block diagram of an exemplary embodiment of a television signal decoder according to the present invention;

FIG. 4 is a flowchart that illustrates a method according to the present invention.

### DETAILED DESCRIPTION OF THE PREFERRED EMBODIMENT

The characteristics and advantages of the present invention will become more apparent from the following description, given by way of example. One embodiment of the present invention may be included within a hardware device, such as a television or a set top box. Another embodiment of the present invention may use software on a computer, television, telephone, or tablet. The exemplifications set out herein illustrate preferred embodiments of the invention, and such exemplifications are not to be construed as limiting the scope of the invention in any manner.

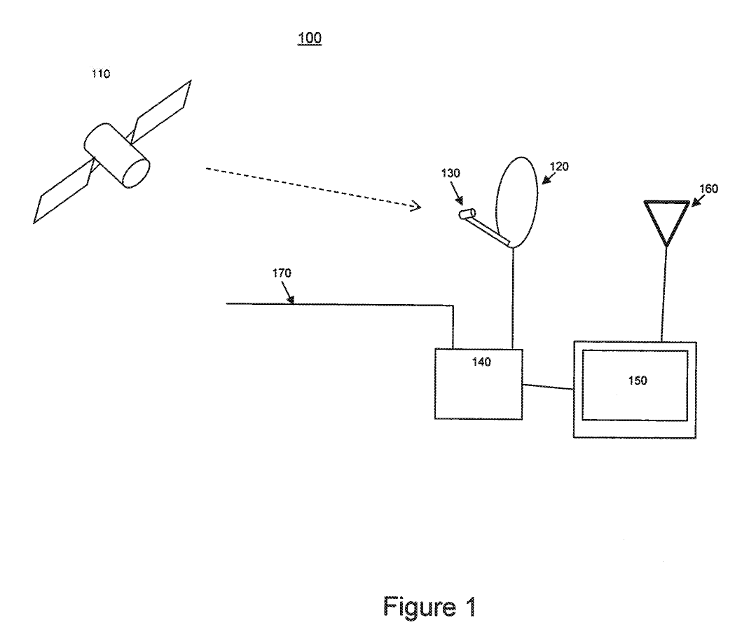

Referring to FIG. 1, a diagram of an exemplary embodiment of an audio video reception system is shown. FIG. 1 shows a transmitting satellite 110, a parabolic dish antenna 120 with a low noise block 130, a set top box 140, a television monitors receiver 150, an antenna 160, and a source of a cable television signal.

A satellite broadcast system operates to broadcast microwave signals to a wide broadcast area. In a digital television broadcast system, this is accomplished by transmitting the signals from a geosynchronous satellite 110. A geosynchronous satellite 110 orbits the earth once each day and sits at approximately 35,786 kilometers above the earth's surface. Since a digital television broadcast satellite 110 generally orbits around the equator it constantly remains in the same position with respect to positions on the ground. This allows a satellite receiving antenna 120 to maintain a fixed look angle.

A digital television transmitting satellite 110 receives a plurality of signals from an uplink transmitter and then rebroadcasts the signal back to earth. The altitude of the transmitting satellite 110 allows subscribers in a wide geographical area to receiving the signal. However, the distance from the earth and the severe power conservation requirements of the satellite also result in a weak signal being received by the subscriber. It is therefore critical that the signal be amplified as soon as possible after it is received by the antenna. This requirement is achieved through the placement of a low noise block (LNB) 130 at the feed horn of the parabolic dish antenna 120.

The LNB 130 converts the signals to a format conducive to transmission over a closed link transmission means, such as a coaxial cable or an Ethernet cable. These signals are then conducted to a set top box 140. For this exemplary embodiment, a set top box 140 may be a satellite set top box capable of receiving digital or analog satellite signals. In addition, the set top box 140 may be a cable set top box for decoding digital or analog cable, or the set top box may be a digital video disc player, a digital video recorder, a video cassette recorder, or an internet protocol enabled device. The set top box 140 may be any device capable of producing or processing a signal comprising an audio video stream with auxiliary information. This auxiliary information may be closed captioning information or subtitles, metadata, character information (“Who is that character?”), appropriate for that point in the story, inside joke descriptions, the meaning of slang and obscure terms, actor information for characters recently or currently in the scene, actual audio or video, if displayed on second screen, PIP window and/or headphones for an individual user, or speech to text rendition. The set top box is then operative to output an output signal comprising an audio video stream with auxiliary information.

A television 150 is operative to receive the output signal from the set top box 140 and display the audio video program to a viewer. While the output signal comprises auxiliary information, this auxiliary information may be either displayed in the video signal in a traditional sense as part of the picture, or it may be embedded in the signal and extracted and displayed by the television 150. The television 150 may be further operative to receive audio video signals with auxiliary information without the use of the set top box 140. The television 150 may be operative to receive over the air broadcast signals, such as ATSC signals, via an antenna 160. Additionally the television 150 may be capable display audio video programs receive via a cable source 170, internet protocol signals, or playing media directly from a storage medium, such as a USB memory source.

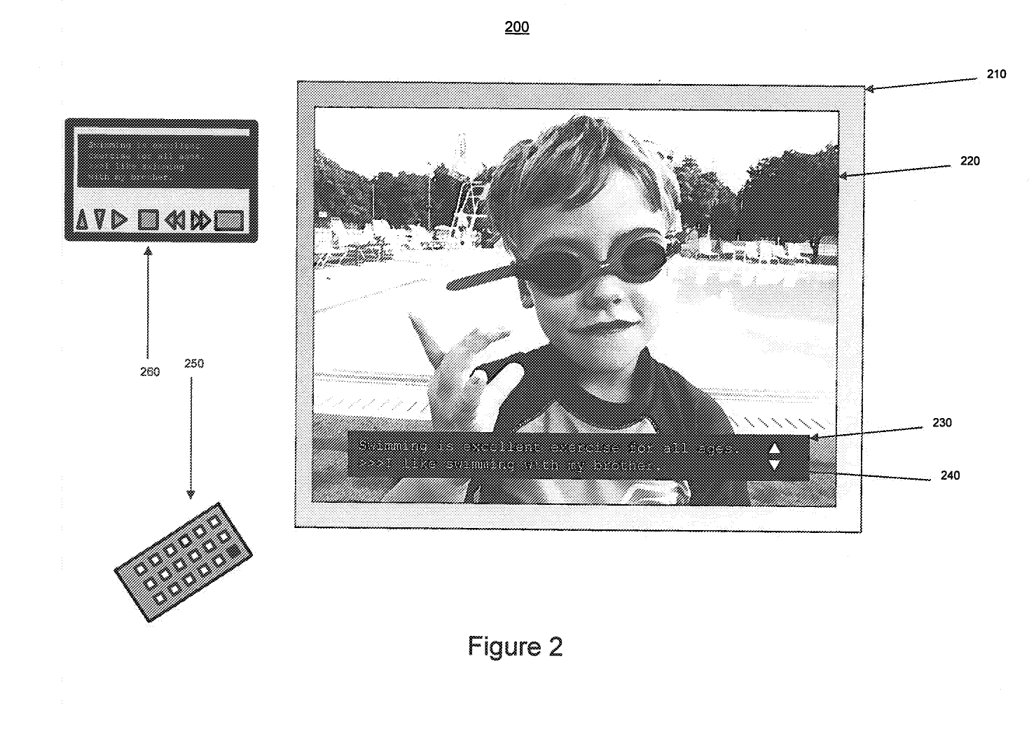

Referring now to FIG. 2, a block diagram of an exemplary embodiment of a television display 200 according to the present invention is shown. The television 210 is operative to display an audio video program 220 having embedded auxiliary information. For this exemplary embodiment, the auxiliary information shown is closed captioning data 230. Additionally for this exemplary embodiment, the television 210 performs the manipulation of the auxiliary information, however, this manipulation may also be done by the set top box 140 of FIG. 1.

According to one aspect of the system, the television receiver buffers the closed caption data, without necessarily displaying it at the conventional time during normal playback. In response to the user pushing a “recall” or similar button on the remote control 250, the system will textually display an appropriate amount of recent dialog on the screen. The appropriate amount may be determined by a combination of time (e.g. 15 seconds), natural breaks (e.g. sentence or paragraph), a number of words (screen-full), etc. Meanwhile, the normal video and audio continue to play, so the entertainment experience is minimally disturbed. When the auxiliary information 230 is displayed, arrows 240 may be displayed to indicate to a viewer that additional information is available in the buffer either before or after the current information being displayed. If no additional information is available either before or after, the currently displayed auxiliary information

Optionally, a second screen device, such as a mobile phone or tablet 260, may be used for displaying the auxiliary information information. In this embodiment, an application on the tablet 260 would be aware of the identity of the program content (e.g. movie name), and the time position within it. This information can be determined in a number of ways: directly from the content stream via the player, from audio content recognition techniques, by the use of watermarking techniques, etc. When the user pushes a “What just happened?” button, the application may go to a cloud service to retrieve and display of a synopsis of recent plot developments based on the content identity and time position. Similarly, when the user pushes a “What did he/she just say?”, the application could go to the cloud service to retrieve the recent dialog for display on the tablet or phone. This exemplary embodiment would allow for the invention to be used on entertainment content in which there is no augmentation data embedded in the delivered stream. Alternatively, the tablet 260, could receive the information from the television via software installed on the television and/or the tablet. These two methods of receiving information are not exclusive to each other.

The display of the auxiliary information may be initiated through any combination of remote control 250 buttons, soft-keys on a tablet 260 or phone, voice recognition, for example someone says “What did he say?”, or using a designated keyword such as “Media-what?” Additionally the display may be initiated by gesture recognition, such as someone raising their hand, or mood/expression recognition, such as a viewer giving a quizzical look such as a raised eyebrow or the like.

The auxiliary information may be optionally or additional obtained by buffering data in the content, such as closed caption data. Part of the buffering process will typically produce a time-indexed database of the augmentation data. The information may be obtained using an independent synchronized stream that is not embedded with the data, for example, receiving closed-caption data for the show from a separate source. A pre-prepared time-indexed database for the content may be accessed either in a cloud or in local storage.

To recognize position of auxiliary information with respect to the content metadata delivered with the program stream, such as content ID and timestamp, may be used. In addition or alternatively, the system may use audio content recognition, watermarking information embedded in the audio or video to be output, and/or user inputs of the content title and/or the approximate position from a tablet or phone application.

What auxiliary information to be displayed at initiation of the display of auxiliary information, particularly when the user was likely to not have understood the programming, would make the system more user friendly. This may be accomplished by using a predetermined time delay, such as 12 seconds. This 12 seconds may be indicative of how long a viewer needs to find the remote and press the appropriate button. This predetermined time may be learned by the device and altered depending on viewer use characteristics. Additionally or optionally, the system may monitor the ambient environment to try to determine when a viewer is distracted and providing information of what happened during the distraction. This could be based on environmental speech, not part of the audio video programming, or loud noises. This may involve monitoring the listening and viewing environment, subtracting the audio from the show, and processing the result similar to echo cancellation. The system may user face detection or the like to determine when a viewer was distracted, for example, by determining when a viewer was looking away from the television. When the viewer then presses the button to initiate the auxiliary information system, the appropriate context to display would be for the time when they were not looking. The system may detect when someone left the room, and remember the time period. After they return and may later press the button, you can display synopsis information for the part of the show they missed, even if it was a long time ago. For example, someone leaves the room and then comes back and thinks they didn't miss anything important. Later they get confused because subsequent developments depended on what they missed. When they press the UI button, they could get character or plot developments during the gap. It would be possible to highlight elements within the information where there is an overlap between what was missed and the current scene, for example which characters are common.

Additional capabilities of the user interface system, either on the tablet 260 or the television 210, may include if the user presses the “recall” button multiple times for the same scene, progressively more information could be displayed. If a single user presses the button often, for example for someone who is hearing impaired, additional data could be readied for their use and/or automatically displayed. The system may comprise an option for a viewer to select a “Did this help?” selection and direct them to additional information in the cloud and/or log the information as a request to provide more useful augmentation data. This information on when viewers requested augmentation data may be logged, collected, and aggregated, either at a local level or a multiuser level, to improve the system response. This may either improve the augmentation data or improve the content, such as in pre-production screenings. For example, if many viewers initiate the system after a particular sentence, the content creator may wish to rerecord the sentence to improve the content.

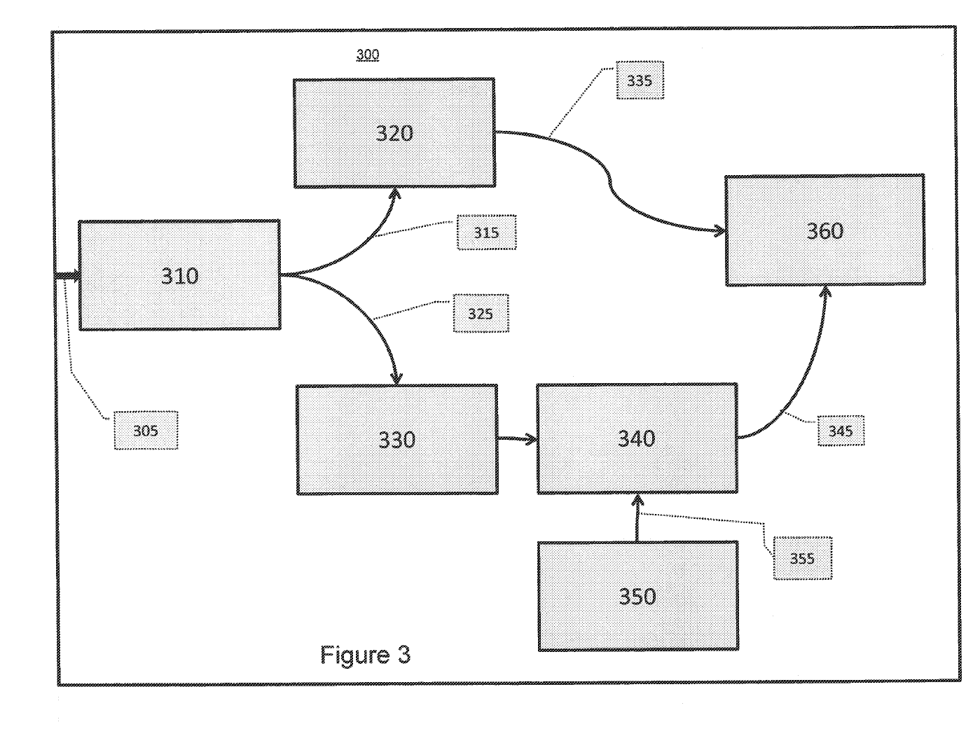

Turning now to FIG. 3, a functional block diagram of an exemplary embodiment of a television receiver 300 according to the present invention is shown. The television receiver 300 may comprise a stream demultiplexer 310, a video decoder 320, a closed captioning decoder 330, an audio video display 360, a time stamped buffer 340, and a user interface 350.

The stream demultiplexer 310 is operative to demultiplex the audio video program stream 305 into an audio video data stream 315 and a closed captioning data stream 325. The video decoder 320 is operative to process the video signal to generate a decoded audio video signal 335 suitable for display on a display device. The decoded audio video signal 335 is then coupled to an audio video display 360 where it is displayed for a user. The closed captioning decoder 330 is operative top process the closed captioning data stream 325 to generate captions 345 for the dialog and the like within the audio video program, an audio video display 360. These captions are buffered within a time stamped buffer 340 for a predetermined amount of time, such as 30 minutes. A user may initiate display of the closed captioning information or any additional auxiliary information in a manner described previously through a user interface 350. The user interface may be displayed on the tablet or television, or optionally may be accessed through key strokes on the remote without displaying a graphical user interface.

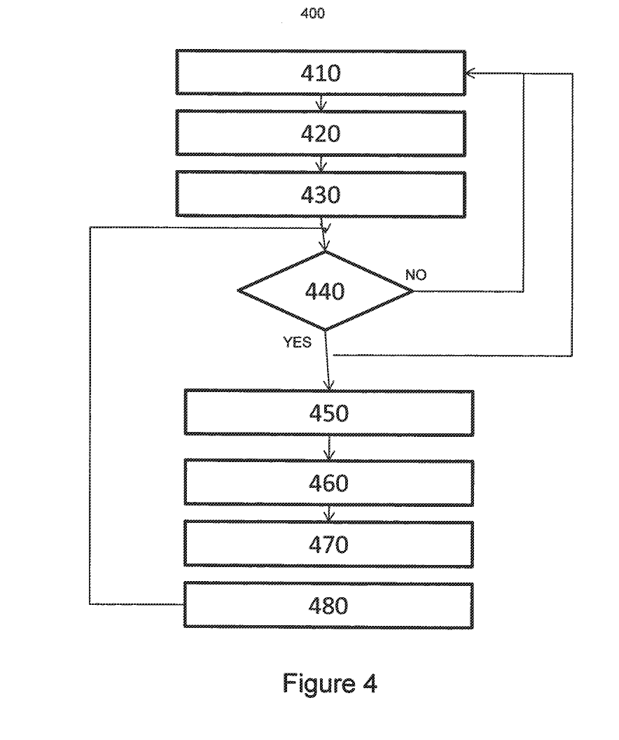

Turning now to FIG. 4, a flow chart illustrating a method 400 according to the present invention is shown. The system is operative to receive a signal comprising audio video programming and auxiliary information 410. The system is then operative to process the signal and extract the auxiliary information 420. The auxiliary information is buffered in a memory 430 or the like. The system then determines if a request has been made to display the auxiliary information 440. If no request has been made, the system returns to the receiving step 410. If a request has been made, the system determines a start time for the buffered auxiliary information 450 any one of the processes received earlier. In addition, if a request has been made, the system returns to the receiving step 410 to continue receiving auxiliary information in parallel to the following steps. Once a start time has been determined, where the start time is prior to the time of the currently displayed video, the auxiliary information is displayed 460 on the television or the tablet. The system permits the viewer to scroll through the buffered auxiliary information 470. The system displays the auxiliary information until a request is made to cease the display of the auxiliary information 480. This request may be made in response to a viewer request, or the expiration of a predetermined amount of time. When the display of information is ceased, the system then returns to the request step 440 to determine if another request for auxiliary information has been made.

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for informational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herewith represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

Although embodiments which incorporate the teachings of the present disclosure have been shown and described in detail herein, those skilled in the art can readily devise many other varied embodiments that still incorporate these teachings. Having described preferred embodiments for a method and system for disparity visualization (which are intended to be illustrative and not limiting), it is noted that modifications and variations can be made by persons skilled in the art in light of the above teachings.

1. A method of processing a signal comprising the steps of:
extracting auxiliary information from an audio video signal;
buffering said auxiliary information;
displaying a video stream extracted from said audio video signal;
displaying a first portion of said auxiliary information in response to a first request; and
displaying a second portion of said auxiliary information in response to a second request.

2. The method of claim 1 wherein said second portion of said auxiliary information was received prior to said first portion of said auxiliary information.

3. The method of claim 1 wherein said second portion of said auxiliary information was received after said first portion of said auxiliary information.

4. The method of claim 1 further comprising the step displaying an arrow indicating the availability of a third portion of said auxiliary information.

5. The method of claim 1 wherein said first portion of said auxiliary information corresponds to a first previously displayed portion of said video stream.

6. The method of claim 1 wherein said second portion of said auxiliary information corresponds to a second previously displayed portion of said video stream.

7. The method of claim 1 wherein said first request is generated in response to a signal received from a remote control.

8. The method of claim 1 wherein said first request is generated in response to an audio signal.

9. The method of claim 1 wherein said first portion of said auxiliary information and said second portion of said auxiliary information are displayed on a second screen, separate from the display of said video stream.

10. The method of claim 1 wherein said auxiliary information is closed caption data.

11. The method of claim 1 wherein said auxiliary information is metadata.

12. An apparatus comprising:
an input for receiving an audio video signal;
a processor for extracting auxiliary information from said audio video signal, for generating a video stream in response to said audio video signal and said extracted auxiliary information wherein said video stream includes a first portion of said auxiliary information in response to a first request and a second portion of said auxiliary information in response to a second request.
a memory for buffering said auxiliary information;
an output for coupling said video stream to a display.

13. The apparatus of claim 12 wherein said second portion of said auxiliary information was received prior to said first portion of said auxiliary information.

14. The apparatus of claim 12 wherein said second portion of said auxiliary information was received after said first portion of said auxiliary information.

15. The apparatus of claim 12 wherein said video stream further comprises an arrow indicating the availability of a third portion of said auxiliary information.

16. The apparatus of claim 12 wherein said first portion of said auxiliary information corresponds to a first previously displayed portion of said video stream.

17. The apparatus of claim 12 wherein said second portion of said auxiliary information corresponds to a second previously displayed portion of said video stream.

18. The apparatus of claim 12 wherein said first request is generated in response to a signal received from a remote control.

19. The apparatus of claim 12 wherein said first request is generated in response to an audio signal.

20. The apparatus of claim 12 wherein said first portion of said auxiliary information and said second portion of said auxiliary information are displayed on a second screen, separate from the display of said video stream.

21. The apparatus of claim 12 wherein said auxiliary information is closed caption data.

22. The apparatus of claim 12 wherein said auxiliary information is metadata.
